(19) United States
(12) Patent Application Publication
(10) Pub. No.: US 2019/0108473 A1
(43) Pub. Date: Apr. 11, 2019

(54) Method and System for Purchase Inventory

(71) Applicant: Charles Saunders, III, Boulder, CO (US)

(72) Inventor: Charles Saunders, III, Boulder, CO (US)

(21) Appl. No.: 15/730,338

(22) Filed: Oct. 11, 2017

(51) Int. Cl. G06Q 10/08; H04L 12/28; G09B 19/00; G06F 19/00

(52) U.S. Cl. CPC G06Q 10/087; H04L 12/2825; H04L 12/2829; G06F 19/3418; G06F 19/3475; G06F 19/3431; G09B 19/0092

(57) ABSTRACT

A system and method for tracking and processing user purchase information. The system and method include receiving and processing information related to the purchase of goods and services of a user. The information is manipulated by the system to aid the user in his or her daily eating and living routines.

### FIELD

The described embodiments relate generally to household management systems. More particularly, the present embodiments relate to a method for determining the inventory of certain household goods. In still greater particularity, the embodiments relate to utilizing information from retail suppliers relating to goods purchased in conjunction with consumption and purchase data from a purchaser.

### BACKGROUND

Recent advances in portable computing have permitted users to increase their control over their lives by providing them with more information. This information may be gained by tracking the user's habits as to eating and exercise for example. The information may also be gathered from external sources. For example, a purchaser's history of grocery or other goods purchased may be accessed through a retailer loyalty or other retailer program to which the user belongs. Other methods of gathering purchaser data may also be employed. For example, as described in US patent application publication US2009000615 entitled “Collection of Receipt Data from Point of Sale Devices, the disclosure of which is hereby incorporated by reference and made part hereof for all purposes, sales data from various retailers may be gathered.

Retailers have instituted loyalty programs in recent years to enhance purchaser loyalty to the retailer. For example, certain grocery chains grant a purchaser credits which may then be used to redeem new purchases or used a credit against gas or other purchases at the grocery chain. Other retailers may use the purchaser's loyalty to enter them in contests or for other product promotions or discounts. The advantage to retailers, in addition to garnering customer loyalty, is that information on the purchasers purchasing habits may be gained from tracking the customer purchases.

While the information regarding a customer's purchasing habits may be useful to the retailer, it may also be of significant value to the customer. For example, as disclosed in U.S. Pat. No. 7,249,708, entitled Household Management Systems and Methods, the disclosure of which is incorporated herein by reference and made part hereof for all purposes, various purchase and use information may be catalogued and used by consumers.

One system shown in US Patent application 20140180853 entitled “Framework for generating a Personalized Item List” hereby incorporated by reference and made part hereof for all purposes, uses information obtained from consumer purchases through a retailer's database to create a shopping list for a consumer.

### SUMMARY

A method is disclosed to collect information on the purchasing habits and actual purchase made by a consumer. That information may be correlated with a user's health, fitness activities, medical history and conditions to provide the user, and those individuals granted access by the user, with usage information and with information regarding needed items to be purchased or obtained by the user.

The method may include a warning system to warn the user that he or she may need to reduce or eliminate future intake of a certain food or foods. The food consumption and physical activity stored by the system can be supplied to the user and to the user's medical professionals. The system can analyze the information to predict the user's future health status as well as provide a warning to the user if his or her health status is put in jeopardy by the user's eating habits and type of food consumed.

The system can include a personal computing device such as a smartphone or laptop computer or other electronic apparatus. A database can be kept and the information may be provided to the user or other selected individual by wireless or other electronic communication means. For example, the information could be accessed from an internet site or provided directly to the user device by wireless transmission.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a flow chart illustrating the method for creating and utilizing a purchase inventory;

FIG. 2 shows a perspective view of a system and method for obtaining and utilizing purchase information;

FIG. 3 shows a perspective view of an electronic device and system for inputting and displaying purchase and user information; and

FIG. 4 shows a perspective view of an alternate electronic device for or inputting and displaying purchase and user information.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

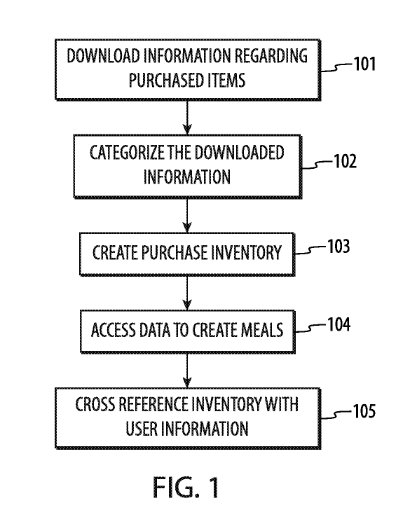

Various embodiments are discussed below with reference to FIGS. 1-4. However, those skilled in the art will readily appreciate that the detailed description given herein with respect to these Figures is for explanatory purposes only and should not be construed as limiting.

Referring to FIG. 1, in operation 101, a direct download of information regarding items purchased from a vendor's point of sale system may be used in one embodiment. For example, consumer purchases from a grocery store, restaurant or other retail establishment may be tracked and the information may be sent to a database. Once an identifier has been entered by the consumer or vendor at the point of sale, the vendor's system may store the information and/or transmit data relating to the purchase to the individual consumer's personal account or portable computing device. The transmission may utilize wireless or wired services or may store the information on cloud databases. The information may be retrieved offsite by entering an identifier assigned by the vendor and given to the purchaser either on the sales receipt or sent to a customer electronically by email, text message, or by other means.

A number of identifiers can be used to access the information such as store/vendor loyalty card number, credit/debit card number via swipe, chip reader or proximity payment services, manually inputting a telephone number, or use of a unique and personal number, password or phrase. Other sources of merchandise purchase information could be obtained from the user's use of a credit card or other purchasing technology such as Pay Pal, Apple Pay or other technology. In one embodiment, a bar code or other information storage information may be read from a receipt in order to identify the items purchased.

Data transmitted and stored may include, but is not limited to, store information, date and time of sale, date and time of information transmission, description of the item purchased, the quantity of each item, price of each item, expiration date of an item if perishable which may be either stated or derived, the item's UPC code or other identifying information and the total cost (including tax) of the item,

Referring again to FIG. 1, in operation 102, once the data has been transmitted to the personal account/database, the information can be categorized and used in a variety of applications. The identified purchases can be separated into categories such as groceries, prescription or non-food items. In operation 103, a purchase inventory can be created and, for example, grocery information can be used to replenish the user pantry. For example, when a recipe is used, the system could deduct the amount of ingredients used from the user's inventory and can create a shopping list to replenish the needed ingredients for a preferred recipe. Information on nutritional values could also be used as part of health programs or provided to a user's healthcare professional. The system could also be used to track expiration dates of food items or items which are part of a recall. In another embodiment, the system will notify the user of any product recalls or approaching expiration dates.

In one embodiment, in operation 104, the user can access the data in order to create meals. After the user indicates that a meal has been consumed, the system will track the use of the ingredients. The system will decrease the inventory of ingredients representing the quantity of the items used in the corresponding recipe for that meal. If the system determines that the quantity of an item is below a certain threshold, the system will then notify the user that the amount on hand of a particular item is getting low in the database inventory. The system may generate a shopping list and automatically add the item or it may allow the user to do so depending upon user input and preference.

In operation 104, after locating a recipe a user wishes to make, the user can input the recipe ingredients and quantities into the system via download from the web or scan a symbol located on a recipe. Once in the system, the system can verify that the necessary ingredients and in the necessary amounts for the recipe are in the user's digital pantry. If the digital pantry is missing a necessary item listed in the recipe, then a shopping list may be created that contains items needed for that particular recipe. The user can add more recipes and the system will update the shopping list as necessary. In some embodiments, the system will reconcile and verify the digital and actual pantry inventory.

In an alternate embodiment, in operation 104, instead of the user searching various recipes, the system can search various websites that contain recipes and suggest a meal based on the contents of the digital pantry. In another embodiment, the user can input the user's culinary preference and the system can suggest a recipe based on the users' culinary preference (e.g. Mexican). The system may access a recipe in the database or online and verify that the user has the requisite ingredients in sufficient quantities to prepare the particular meal.

In optional operation 105, the system may cross reference the inventory with a user's personal information such as medical, fitness or other information. The system can suggest a recipe based on the user's health status, medical condition, health and fitness goals, desired caloric intake or the like. For example, a user's proclivity to eat certain foods may be identified and a warning system can be triggered if the user attempts to access or prepare a meal which could be detrimental to his or her physical well-being.

In operation 105, the system could act as an early warning system when the user inputs a soon-to-be consumed meal/recipe to notify a user that he or she may be allergic to certain ingredients or that the user had a medical reaction or became ill when consuming certain ingredients. For example, if the user has a peanut allergy, the system may notify the user that a certain ingredient or foodstuff purchased may contain peanut ingredients. Similarly, a user's sensitivity to other substances such as monosodium glutamate or gluten containing products such as those related to celiac disease may be identified. In another embodiment, a user who is diabetic may rely on the system to notify him or her that substances such as sugar are present in certain foods or ingredients the user may be about to consume.

Over the past few years, there has been a trend to track and record a person's physical activities such as, for example, walking, running, ultimately measuring the number of calories burned during the total sum of activities. Conventional programs/applications attempt is balance the number of calories burned with the caloric intake. In order for this to occur the user is required to manually input meals consumed. Unfortunately, this is a time consuming task which leads to irregularities and reporting errors, as well as the lack of reporting resulting in inconsistent and unusable data. The task of manually recording food items/meals consumed can be alleviated by employing a direct download of items purchased from a food venue-grocery store, restaurant, or other retail establishment, into the user's personal database/account in operation 101.

In operation 105, the system could also be used to cross reference foods purchased or consumed, either at home or at a fast food or other restaurant, with the user health and fitness information. The amount of calories consumed could also be tracked in this manner. When used in combination with a fitness tracker, the user's net intake or calorie burn could be measured, displayed and/or stored.

In operation 105, the system can obtain and store nutritional values of food items transmitted to the database. By obtaining this information, the user can then create recipes from the items, and the system will provide the nutritional values for that meal. The nutritional values can be used in medical/health/fitness etc. applications and programs, in order to balance calories burned vs. caloric intake. This information can then be used in order to achieve medical, health and fitness goals as well as to be conveyed to user's healthcare personnel in order to improve the user's health. The system may suggest a diet and individual recipes based upon the user's fitness goals and desired weight or other parameters entered into and stored in the system.

In operation 105, the system could warn user that they may need to cut back on a particular food/recipe due to the fact that they have gout, high blood pressure, or other types of conditions. In another application, the prescription and its normal effects to the user can be included in the overall nutrition/exercise scheme for a better picture of the user's health. This information can be used to determine if either or both of the nutrition and exercise regimen need to be adjusted in the best interest of the uses health goals. In operation 105, a prescription medicine component could also be included. The system could also be used to trigger prescription refills or signal a drug interaction between certain medications, whether over-the-counter or prescription medications.

In an embodiment which includes purchase information regarding food and products other than food, in operation 101, the system could also be used to track warranty information and product recalls. Product rebates could also be tracked. The system could also be linked to how-to videos and other instructions for use of a product, either on-line or sent by written description.

In another embodiment, in operation 103, the system can notify the user of the possibility that the inventory of non-grocery items is reaching a low inventory level. Such items can include, but not limited to personal items such as body lotion, toothpaste, soap, detergents, and automobile gas fill ups. The system can also alert the user that service items such as haircuts and oil changes may be due based upon the past purchase history of the user for these items and services.

In another embodiment, in operation 103, an inventory of household items, such as furniture, guns, jewelry and vehicles can be entered into and stored in the system upon purchase for insurance and maintenance reasons. In another embodiment, in operation 101, the purchase information regarding the date of purchase of these and other items can be stored in the system. For example, the store or vendor name and the price and quantity can be transmitted and stored in the system. That information could be transmitted to an electronic trading database such as Quicken. Purchase information can also be stored for later expense or tax reporting.

In another embodiment, in operation 105 purchase data from the point of sale direct download may be used to analyze nutritional information, medical/health condition of the user physical activity and related information to determine the user's optimal diet, physical activity to improve the health of the user

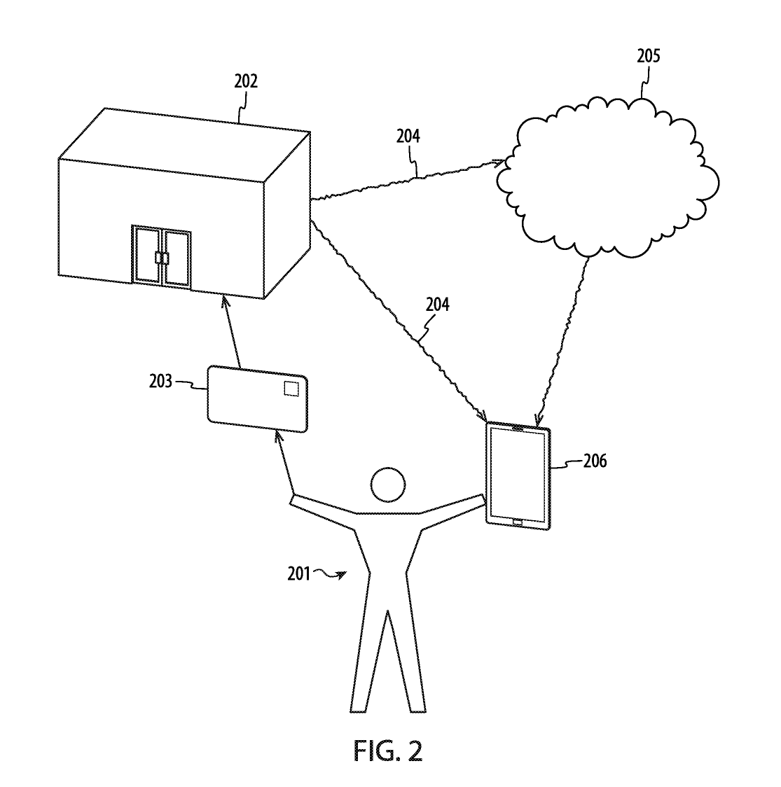

Referring to FIG. 2, a schematic illustrating the system is shown. A user 201 may purchase goods or services at a retail establishment 202 using a credit card, loyalty card, or other identifier 203. It should be understood that retail establishment may also include an online store and is not to be limited to a bricks and mortar type establishment. The retail establishment may send information 204 to a storage system 205. Storage system 205 can be cloud based or may be the stores own database and storage system. In some embodiments, information 204 is sent to the database 205 and then conveyed to a portable electronic device 206 of user 201.

In some embodiments, information 204 may be sent directly to portable electronic device 206 from retail establishment 202. The information 204 may include the type of good or service purchased as well as the price and the ingredients in the case of a foodstuff all as described herein. Warranty and other information 204 related to the product or service may also be stored and sent to user device 206. Device 206 may be a wired or wireless device. For example, device 206 could be a smartphone or it could be a wired device such as a desktop computer with the information sent wirelessly or through a wired connection.

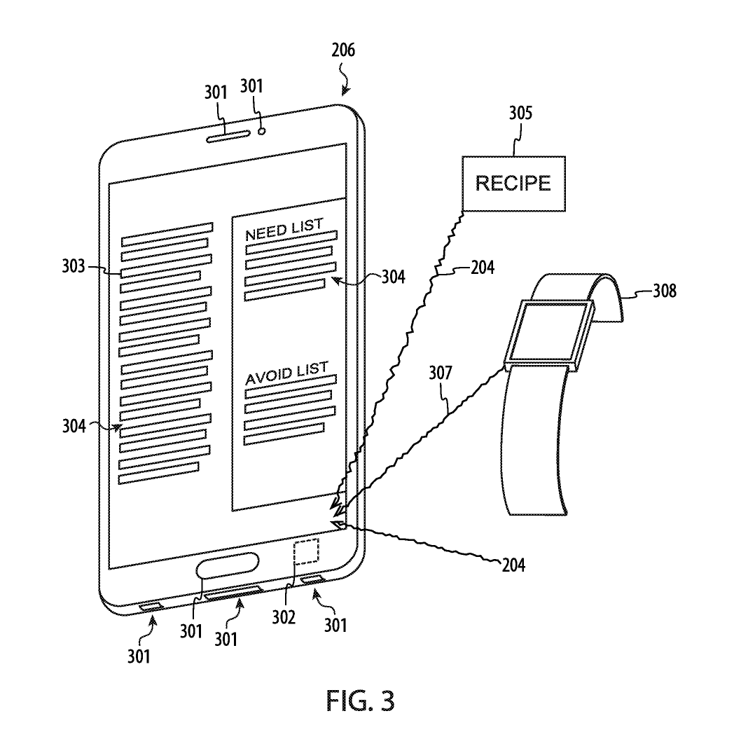

Referring to FIG. 3, device 206 is shown in perspective view. Device 206 may be a conventional smartphone or other electronic device. Device 206 includes various information input and output apparatus 301 and a control device 302 to store and process information 204 received from a retail establishment.

Control device 302 may execute instructions and carry out operations associated with portable electronic devices as are described herein. Using instructions from device memory, controller 302 may regulate the reception and manipulation of input and output data between components of the electronic device 206. Controller 302 may be implemented in a computer chip or chips. Various architectures can be used for controller 302 such as microprocessors, application specific integrated circuits (ASIC's) and so forth. Controller 302 together with an operating system may execute computer code and manipulate data such as received data 204. The operating system may be a well-known system such as iOS, Windows, Unix or a special purpose operating system or other systems as are known in the art. Control device 302 may include memory capability to store the operating system and data such as data 204. Control device 302 may also include application software to implement various functions associated with the portable electronic device 206. For example, control device may manipulate data 204 with other received or stored data to output information to a user.

Referring again to FIG. 3, device 206 includes a display screen 303 to visually display information 304 to a user. Screen 303 may also be a touchscreen to allow user 201 to input data into device 206 and into control unit 302. Information 304 may include a list of food items contained in the user's pantry and items needed to prepare a meal based upon a recipe 305 which may be stored in controller 302 or which may be received as information 204 or which may be manually input into the device 206 by a user. Information 304 may also include user spending information, recall information, warranty information, prescription information, medical information and all other information as described herein. In addition, information 304 may include fitness information 307 received from a fitness device 308 which is stored and processed in control device 302.

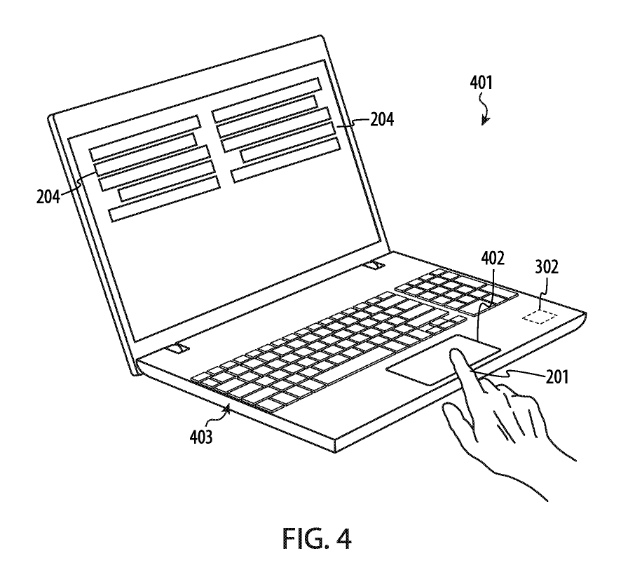

Referring to FIG. 4, in another embodiment, a laptop computer 401 may be used in place of, or in addition to, electronic device 206. Computer 401 may be a laptop computer, a device such as an iPad, or a desktop or other electronic device. User 201 may input data into device 401 through a touchpad 402 or a keyboard 403 or a display screen 404 which may also be a touchscreen. Computer 401 contains a controller 302 and displays information 204/304 as described previously. Computer 401 may receive and transmit information wirelessly or by wired connection to or from other devices and may access the internet as is known to one skilled in the art.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method for utilizing purchased items comprising:
downloading information regarding items purchased onto a portable electronic device;
categorizing the purchase information;
creating a purchase inventory; and
accessing the purchase inventory list.

2. The method of claim 1 wherein the operation of downloading includes a description and quantity of the items purchased.

3. The method of claim 1 wherein the operation of downloading includes purchase date and time information as well as an expiration date for the items.

4. The method of claim 1 wherein the operation of categorizing includes separating the items into food, prescription, and non-food items.

5. The method of claim 1 wherein the operation of creating includes tracking the amount of goods in the inventory.

6. The method of claim 1 wherein the operation of creating includes the operation of creating a shopping list.

7. The method of claim 1 wherein the operation of accessing includes monitoring and verifying the ingredients and ingredient amounts for a recipe.

8. The method of claim 1 wherein the operation of accessing includes the operation of searching a database for recipes and notifying the user of necessary ingredients needed for a desired recipe.

9. The method of claim 1 further including the operation of tracking product warranty information, product rebates and product recalls.

10. The method of claim 1 wherein the operation of creating includes storing information about purchased goods including price, date of purchase, and vendor.

11. A method for utilizing purchased items comprising:
receiving information regarding items purchased on a portable electronic device;
categorizing the purchase information;
generating a purchase inventory;
accessing the purchase inventory list; and
comparing the purchase inventory list with a user's information.

12. The method of claim 11 wherein the operation of comparing includes cross referencing the inventory list with a user's medical and fitness information.

13. The method of claim 12 wherein the operation of comparing includes warning the user about the user's medical conditions affected by an item on the inventory list.

14. The method of claim 11 wherein the operation of comparing includes tracking a user's caloric intake compared to desired fitness goals.

15. The method of claim 11 further including the operation of providing instructional videos related to the purchased items.

16. The method of claim 11 wherein the items include services and the method further includes the operation of notifying the user that a service is due.

17. The method of claim 11 wherein the items include prescription medicine and the method further includes the operation of notifying the user of a needed prescription refill.

18. The method of claim 11 wherein the items include prescription medicine and the method further includes the operation of notifying the user of drug interactions.

19. A system for utilizing purchased items comprising:
a personal computing device;
a controller associated with the personal computing device;
an identifier associated with a user and used during purchase of the purchased items; and
a receiving device associated with the personal computing device to receive information associated with the purchased items;
whereby the purchased items may be categorized into a purchase inventory list and compared to stored user information in the personal computing device.

20. The system of claim 19 further including a user fitness device communicatively connected to the receiving device.
